(19) United States
(12) Patent Application Publication
(10) Pub. No.: US 2024/0006916 A1
(43) Pub. Date: Jan. 4, 2024

(54) MODULAR PCB-BASED COIL FOR EV WIRELESS CHARGING WITH THERMALLY CONDUCTIVE SEPARATOR

(71) Applicant: Toyota Motor Engineering & Manufacturing North America, Inc., Plano, TX (US)

(72) Inventors: Yanghe Liu, Ann Arbor, MI (US); Feng Zhou, Ann Arbor, MI (US); Hiroshi Ukegawa, South Lyon, MI (US)

(73) Assignees: Toyota Motor Engineering & Manufacturing North America, Inc., Plano, TX (US); Toyota Jidosha Kabushiki Kaisha, Aichi Prefecture (JP)

(21) Appl. No.: 17/856,461

(22) Filed: Jul. 1, 2022

(51) Int. Cl. H02J 50/10; B60L 53/12; B60L 53/302; H02J 50/40; H02J 50/00; H01F 27/28; H01F 5/00

(52) U.S. Cl. CPC H02J 50/10; B60L 53/12; B60L 53/302; H02J 50/402; H02J 50/005; H01F 27/2804; H01F 5/003; H01F 2027/2809

(57) ABSTRACT

A wireless inductive charging apparatus includes first and second coil boards arranged in parallel, each coil board having a substrate and a first metallic trace forming a first inductive winding disposed on a first surface of the substrate. The apparatus includes an electrically-insulating and thermally-conductive insert board arranged between and adjacent to the first and second coil boards, the insert board including microchannels to provide cooling to the coil boards. The first coil board, the insert board and second coil board are arranged in a stacked formation to generate electric power when exposed to a changing magnetic field. Each coil board can also include a second metallic trace forming a second inductive winding disposed on a second surface of the substrate, the second surface on an opposite side of the substrate relative to the first surface. Additional coil boards and insert boards can be added to the stacked arrangement.

### TECHNICAL FIELD

Embodiments generally relate to electric vehicle charging systems. More particularly, embodiments relate to a modular PCB-based coil for wireless electric vehicle charging.

### BACKGROUND

Wireless inductive charging systems for electric vehicles (EVs) include a receiver and rectifier to transfer power from a magnetic or electromagnetic field, applied in the vicinity of the receiver, to electric power for the electric vehicles. The receiver is typically placed or mounted on the bottom of the electric vehicle (EV) such that a transmitter can be placed in proximity to the receiver to expose the receiver to a changing magnetic field. Such placement of the receiver means that the receiver should be designed to minimize the vertical size or height of the receiver apparatus. Litz wire coils have been used to construct the receiver used for wireless EV charging (Litz wire is a multi-stranded wire made of hundreds or thousands of individually insulated strands). However, use of Litz coils has several disadvantages, such as material cost, excess weight, and requires manual assembly.

### BRIEF SUMMARY

In some embodiments, a wireless inductive charging apparatus includes a plurality of coil boards arranged in parallel, including a first coil board and a second coil board, each coil board including a substrate and a first metallic trace forming a first inductive winding disposed on a first surface of the substrate, and an insert board arranged between and adjacent to the first coil board and the second coil board, the insert board including an electrically-insulating and thermally-conductive material, the insert board including a plurality of microchannels to provide cooling to the first and second coil boards, where the first coil board, the insert board and second coil board are arranged in a stacked formation to generate electric power when exposed to a changing magnetic field.

In some embodiments, a method of constructing an inductive charging apparatus includes arranging a plurality of coil boards in parallel, including a first coil board and a second coil board, each coil board including a substrate and a first metallic trace forming a first inductive winding disposed on a first surface of the substrate, and arranging an insert board between and adjacent to the first coil board and the second coil board, the insert board including an electrically-insulating and thermally-conductive material, the insert board including a plurality of microchannels to provide cooling to the first and second coil boards, where the first coil board, the insert board and the second coil board are arranged in a stacked formation to generate electric power when exposed to a changing magnetic field.

In some embodiments, an electric vehicle inductive charging apparatus includes a plurality of coil boards arranged in parallel, each coil board including a substrate and a first metallic trace forming a first inductive winding disposed on a first surface of the substrate, a plurality of insert boards, each insert board arranged between and adjacent to a respective two of the plurality of coil boards, each insert board including an electrically-insulating material, each insert board including a plurality of microchannels to provide cooling to the respective adjacent coil boards, and a cooling system to provide a coolant flow through the apparatus via the plurality of microchannels, the cooling system including a plurality of cooling paths and a manifold to modulate coolant flow among the respective insert boards, where the plurality of coil boards and the plurality of insert boards are arranged in a stacked formation to generate electric power when exposed to a changing magnetic field.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIGS. 1A-1C provide diagrams illustrating an example of a wireless inductive charging system for use in an electric vehicle according to one or more embodiments;

FIGS. 2A-2B provide diagrams illustrating examples of a coil board for a wireless inductive charging apparatus according to one or more embodiments;

FIGS. 2C-2D provide diagrams illustrating examples of an insert board for a wireless inductive charging apparatus according to one or more embodiments;

FIGS. 3A-3D provide diagrams illustrating an example of a wireless inductive charging apparatus according to one or more embodiments;

FIG. 4 is a diagram illustrating aspects of an example of a wireless inductive charging apparatus according to one or more embodiments;

FIGS. 5A-5B provide diagrams illustrating an example of a wireless inductive charging apparatus with cooling according to one or more embodiments; and

FIGS. 6A-6B provide flowcharts illustrating an example method of constructing a wireless inductive charging apparatus according to one or more embodiments.

### DETAILED DESCRIPTION

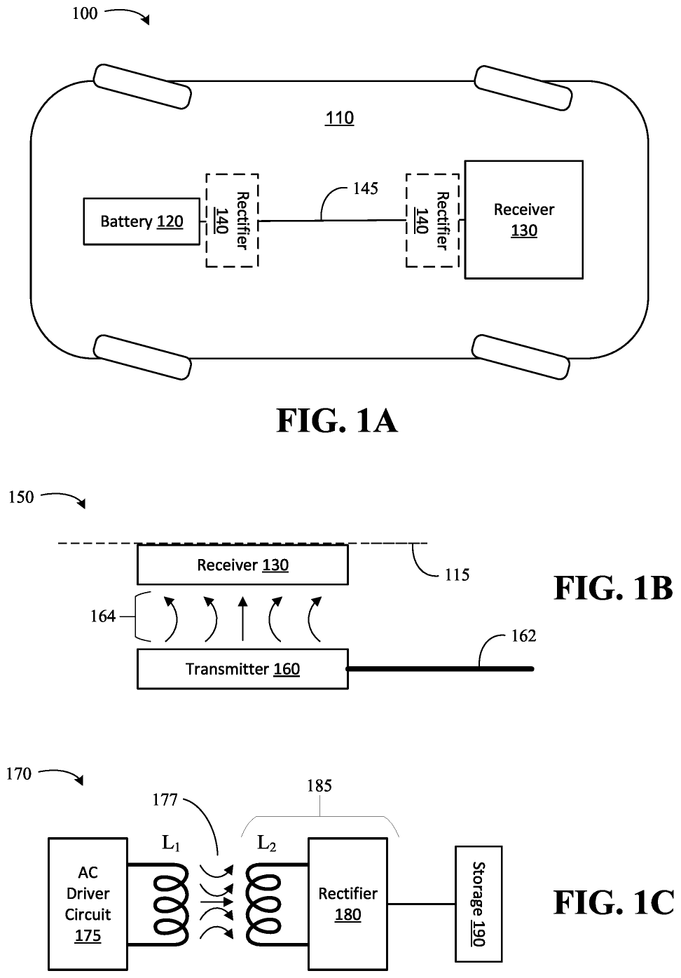

FIG. 1A provides a diagram illustrating an example of a wireless inductive charging system 100 for use in an electric vehicle (such as, e.g., an electric vehicle 110) according to one or more embodiments, with reference to components and features described herein including but not limited to the figures and associated description. The charging system 100 includes a battery 120 to store and supply electric power to the electric vehicle (EV) 110. The charging system 100 further includes a receiver 130 that, in combination with a rectifier 140, converts a magnetic field (which can be an electromagnetic field) (not shown in FIG. 1A) applied in the vicinity of the receiver 130 into electric power to charge the battery 120. The receiver 130 is located in a place on the EV 110 that is accessible to provide the electromagnetic field via an external transmitter (not shown in FIG. 1A). For example, the receiver 130 can be located on the bottom of the EV 110.

The receiver 130 is electrically coupled to the rectifier 140 which, in turn, is electrically coupled to the battery 120. A wire or cable 145 can be used to connect one or more of the receiver 130, the rectifier 140 and the battery 120. The rectifier 140 can be located at a variety of locations between the receiver 130 and the battery 120. For example, in embodiments the rectifier 140 can be located proximate to the receiver 130. As another example, in embodiments the rectifier 140 can be integrated with the receiver 130. As another example, in embodiments the rectifier 140 can be located proximate to the battery 120. As described more fully herein, the receiver 130 is comprised of a plurality of coil boards, each coil board having at least one inductive winding. The receiver 130 operates on the principal of inductive coupling (which can be, e.g., resonant inductive coupling) in which electric power is transferred from a source (e.g., a transmitter, not shown in FIG. 1A) to the receiver 130 via a magnetic field generated by the source.

FIG. 1B provides a diagram illustrating an example of a wireless inductive charging system 150 for use in an electric vehicle (such as, e.g., the electric vehicle 110) according to one or more embodiments, with reference to components and features described herein including but not limited to the figures and associated description. The wireless inductive charging system 150 is illustrated in FIG. 1B from the perspective of a side or rear view of the EV 110. The receiver 130 (FIG. 1A, already discussed) is mounted or attached to an underside 115 of the EV 110. The receiver 130 is designed such that there is room for placement of a transmitter 160 underneath and in proximity to the receiver 130 such that, when electric power is provided to the transmitter 160 such as, e.g., via a cable 162, a changing magnetic field 164 (which can be an electromagnetic field) is generated which passes (e.g., permeates or radiates) into the receiver 130. The receiver 130 in combination with the rectifier 140 transfers power from the magnetic field 164 into electric power via inductive coupling to charge the battery 120. In this way, the receiver 130 generates (e.g., provides) electric power when exposed to a changing magnetic field. For example, the receiver 130 provides AC input power to the rectifier 140 which, in turn, generates DC output power for charging the battery 120.

In some embodiments, the transmitter 160 can be a portable or moveable device that is placed under the receiver 130 during charging and then removed once the charging process is finished. In some embodiments, the transmitter 160 can be a stationary device, while the EV 110 is moved into an appropriate position such that the receiver 130 is located above the transmitter 160 during the charging process.

Placement of the receiver 130 and the rectifier 140 such as, e.g., on the bottom of the EV 110 means that the receiver 130 should be designed to minimize the vertical size or height of the receiver apparatus while providing sufficient power transfer. According to embodiments, a wireless inductive charging apparatus as described herein includes one or more thin, modular, stackable coil boards that provide for reducing and/or minimizing the vertical space required.

FIG. 1C provides a diagram illustrating an example of a wireless charging circuit 170 for use in an electric vehicle wireless inductive charging system such as, e.g., the wireless inductive charging system 150 according to one or more embodiments, with reference to components and features described herein including but not limited to the figures and associated description. The wireless charging circuit 170 can include an AC driver circuit 175, a first coil or inductor L₁, a second coil or inductor L₂, a rectifier 180 and an electric storage device (e.g., a battery) 190. The AC driver circuit 175 is configured to provide AC power to the first coil L₁ sufficient to generate a changing magnetic field 177 which, in turn, passes (e.g., permeates or radiates) into the second coil L₂ when the second coil L₂ is in proximity to the first coil L₁. The AC driver circuit is further configured such that, in conjunction with the first coil L₁, the provided AC power is of a selected frequency.

In embodiments, the selected frequency of the AC power is approximately 85 kHz. In some embodiments, the AC driver circuit 175 in combination with the first coil L₁ corresponds to the transmitter 160 (FIG. 1B, already discussed). In some embodiments, the first coil L₁ (and, alternatively, with additional circuitry) corresponds to the transmitter 160 while the AC driver circuit 175 is remote relative to the transmitter 160. In embodiments, the second coil L₂ corresponds to the receiver 130 (FIGS. 1A-1B, already discussed). In some embodiments, the second coil L₂ in combination with the rectifier 180 corresponds to the receiver 130. The rectifier 180 can correspond to the rectifier 140 (FIG. 1A, already discussed), and the storage device 190 can correspond to the battery 120 (FIG. 1A, already discussed).

When the first coil L₁ and the second coil L₂ are in proximity and when power is applied by the AC driver circuit 175, the magnetic field 177 passes (e.g., permeates or radiates) into the second coil L₂. The second coil L₂ then transfers power from the magnetic field 177 into electric power, via inductive coupling, to be supplied to the storage device 190. In this way, the second coil L₂ generates (e.g., provides) electric power when exposed to a changing magnetic field. The magnetic field 177 can correspond to the magnetic field 164 (FIG. 1B, already discussed). The second coil L₂ can include a plurality of coils electrically coupled, for example, in parallel. In embodiments, the coil L₂ and the rectifier 180 are electrically coupled to form a wireless charging apparatus 185. In embodiments, the wireless charging circuit 170 can include additional components not shown in FIG. 1C.

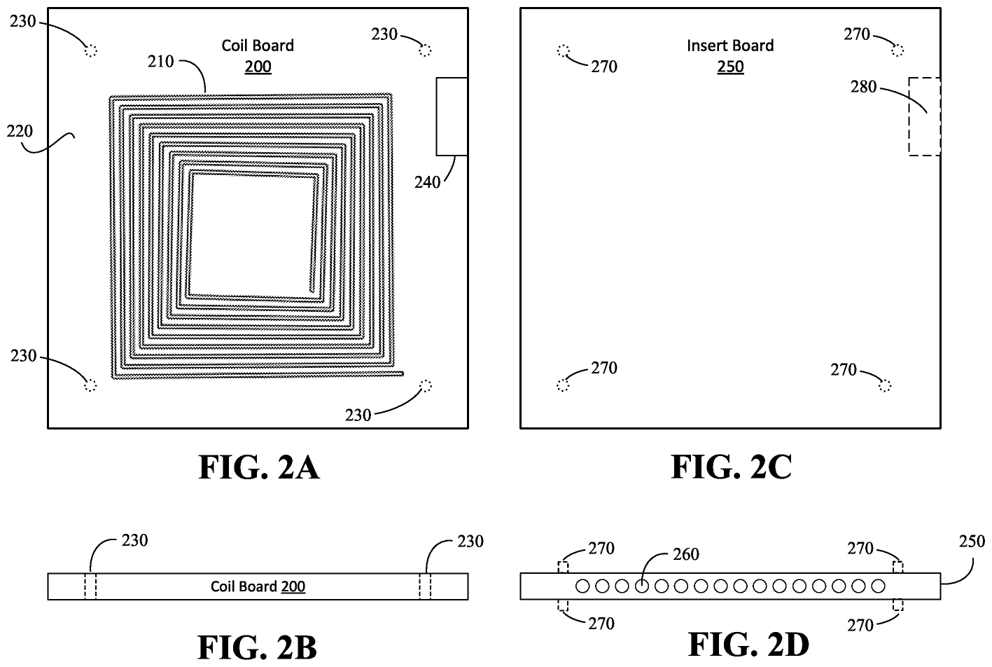

FIGS. 2A-2B provide top and side view diagrams, respectively, illustrating examples of a coil board 200 for a wireless inductive charging apparatus for use in an electric vehicle (such as, e.g., the electric vehicle 110) according to one or more embodiments, with reference to components and features described herein including but not limited to the figures and associated description. The coil board 200 is formed from a printed circuit board (PCB) that includes a first metallic trace that forms a first inductive winding 210 (e.g., an inductive coil winding) disposed on a first surface of a substrate 220. The first metallic trace typically comprises copper. The substrate 220 can be of any material suitable for a printed circuit board, such as, e.g., a fiberglass/epoxy material (e.g., FR4). The thickness of the substrate can be designed for particular system requirements, such as overall system height requirements, strength requirements, etc. In embodiments, the substrate is of a thickness of approximately 1.5 mm.

The first inductive winding 210 as depicted in FIG. 2A is shown for illustrative purposes only. The specific design of the first inductive winding 210, including, e.g., the width of the trace, the number of turns, and/or the overall size of the inductive winding, can be selected as appropriate for the frequency and power requirements of the charging apparatus. For example, the first inductive winding 210 can be designed to accommodate a frequency of approximately 85 kHz; other operating frequencies can be accommodated by the design. As an example, in some embodiments the first inductive winding 210 can be of a size of approximately 350 mm×350 mm with approximately nine (9) turns, approximately twelve (12) traces with trace width of approximately 0.87 mm, and a copper layer thickness of 0.07 mm. Other designs with varying design parameters can be used. The first inductive winding 210 is designed to transfer power, via inductive coupling, from a magnetic field (such as, e.g., the magnetic field 164 in FIG. 1B or the magnetic field 177 in FIG. 1C) when placed in proximity to a source or transmitter (e.g., the transmitter 160 in FIG. 1B) into electric power to be used for charging an EV (such as, e.g., the EV 110 in FIG. 1A).

As illustrated in FIGS. 2A-2B, the coil board 200 does not include a ferrite core or any other magnetic core. The coil board 200 thereby excludes a ferrite core or another magnetic core.

In embodiments, the coil board 200 includes a second metallic trace that forms a second inductive winding (not shown in FIG. 2A or 2B) that is disposed on a second surface of the substrate 220. The second surface is on an opposite side of the substrate 220 relative to the first surface. In such embodiments the coil board can this be considered a two-layer coil board. Like the first inductive winding 210, the second inductive winding is designed to transfer power, via inductive coupling, from a magnetic field into electric power. The second inductive winding, when present, typically has the same design parameters as the first inductive winding 210. In embodiments, the second inductive winding is electrically coupled to the first inductive winding to form a parallel connection. As such, the combination of the first and second inductive windings can transfer more power via inductive coupling than the first inductive winding alone.

In some embodiments, the coil board 200 can have, in addition to the second inductive winding disposed on a second surface of the coil board 200, additional metallic layers or traces (e.g., copper) on the interior of the coil board 200. For example, the additional metallic layers or traces can provide additional inductive windings and/or circuit connections between the first and second inductive windings 210.

In embodiments, the coil board 200 includes one more positioning holes 230. The positioning hole(s) 230 are located so as to avoid interfering with the first and/or second inductive windings, and are located to line up with positioning pins on an insert board (see FIGS. 2C-2D and related discussion herein) to assist in alignment of one or more coil boards and one or more insert boards. For example, in embodiments the positioning hole(s) 230 can be located proximate to one or more corners of the coil board 200. As shown in FIG. 2B, in embodiments the positioning holes 230 can extend through the substrate 220. In some embodiments, the positioning holes 230 can extend into one or more surfaces of the substrate 220 without extending though the substrate 220.

In embodiments, the coil board 200 includes one or more contact pads 240 to provide electrical coupling to the first and/or second inductive windings. The contact pads 240 can be located to provide convenient electrical coupling or connection to the first and/or second inductive windings and to other portions of the charging apparatus. The contact pads 240 can receive one or more electrical connectors (not shown in FIGS. 2A-2B) to provide electrical coupling with the first and/or second inductive windings. The electrical connectors can be permanently or removably installed on the coil board 200.

FIGS. 2C-2D provide top and side view diagrams, respectively, illustrating examples of an insert board 250 for a wireless inductive charging apparatus for use in an electric vehicle (such as, e.g., the electric vehicle 110) according to one or more embodiments, with reference to components and features described herein including but not limited to the figures and associated description. The insert board 250 is formed from a material, such as fiberglass or epoxy/resin, which is electrically-insulating and thermally-conductive. Thermally-conductive material provides for transfer of heat from the coil board(s) 200 to the insert board 250 when the boards are placed adjacent and the coil board(s) 200 are operating to provide electric power. In embodiments, the insert board is constructed from a fiberglass/epoxy material (e.g., FR4). Moreover, the material forming the insert board 250 does not block the magnetic field (e.g., an electromagnetic field) but allows the magnetic field to pass through the insert board to the next adjacent coil board 200. Accordingly, the insert board 250 is non-metallic.

The insert board 250 includes a plurality of microchannels 260 that are situated in the body of the insert board 250 and extend the through the entire length of the insert board 250. The microchannels 260 are arranged so as to permit a flow of coolant entering from one end of the insert board 250, flowing through the body of the insert board 250, and exiting from an opposite end of the insert board 250, thereby providing a cooling mechanism for the charging apparatus.

The thickness of the insert board 250 can be designed for particular system requirements, such as overall system height requirements, strength requirements, etc. In embodiments, the insert board 250 is of a thickness of approximately the same as the thickness of the substrate 220 of the coil board 200. In embodiments, the insert board 250 is of a thickness of approximately 1.5 mm. In some embodiments, when the thickness of the insert board 250 is approximately 1.5 mm, the diameter of each of the microchannels 260 is approximately 1 mm. The insert board 250 can be of other thicknesses, and the microchannels 260 can likewise be of other thicknesses. There is no specific number of microchannels required. In embodiments, there is a sufficient number of microchannels 260 to “cover” (e.g., extend over) the metallic inductive windings 210 on the coil board 200 when the insert board 250 is placed adjacent to the coil board 200.

In embodiments, the insert board 250 includes one more positioning pins 270. The positioning pin(s) 270 are located so as to line up with positioning hole(s) 230 on the coil board 200 (FIGS. 2A-2B, already discussed) to assist in alignment of one or more coil boards and one or more insert boards. For example, in embodiments the positioning pin(s) 270 can be located proximate to one or more corners of the insert board 250. When a coil board 200 and insert board 250 are pressed together the positioning pin(s) 270 fit within the positioning hole(s) 230 so as to keep the two boards in alignment. As shown in FIG. 2D, in embodiments the positioning pin(s) 270 can be located on one surface of the insert board 250 or on two (i.e., opposite) surfaces of the insert board 250. When the insert board 250 has positioning pin(s) 270 located on two (i.e., opposite) surfaces, the insert board 250 can be placed between two coil boards 200 thereby maintaining all three boards in alignment.

In embodiments, the insert board 250 includes an opening (e.g., a cutout region recess) 280 that is located to essentially line up with the contact pad(s) 240 of the coil board 200; the opening 280 may be larger than, the same size as, or smaller than the contact pad(s) 240. The opening 280 accommodates placement of electrical connectors on the contact pad(s) 240 of the coil board 200 when the insert board 250 is pressed together with the coil board 200 without interfering with the electrical connectors.

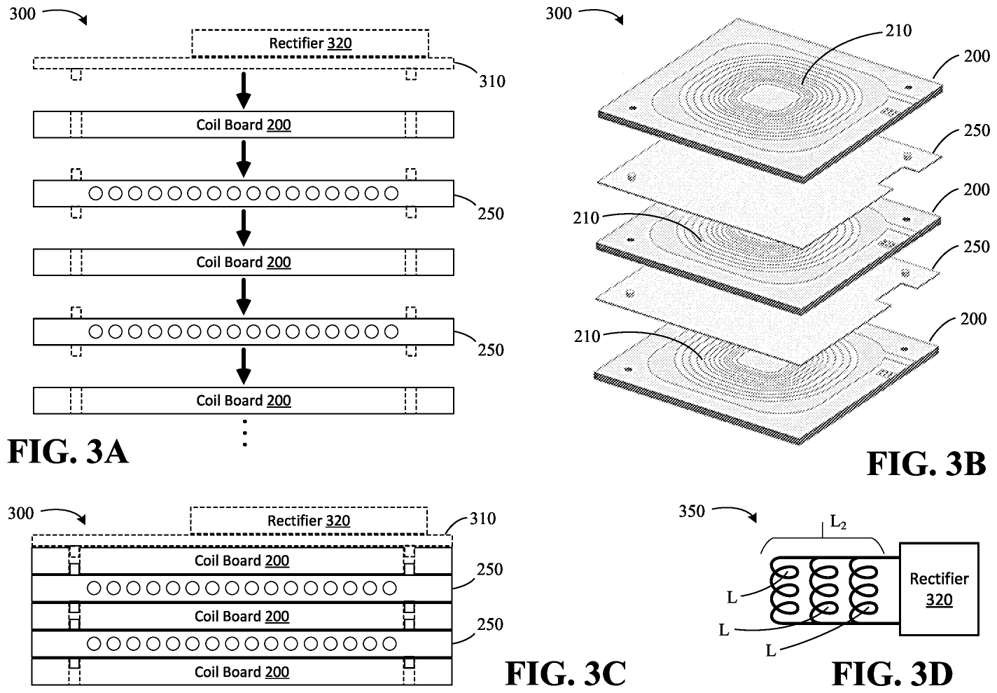

FIGS. 3A-3C provide side and perspective view diagrams, respectively, illustrating an example of a wireless inductive charging apparatus 300 for use in an electric vehicle (such as, e.g., the electric vehicle 110) according to one or more embodiments, with reference to components and features described herein including but not limited to the figures and associated description. As illustrated in FIGS. 3A-3C, the wireless inductive charging apparatus 300 includes a plurality of layers or boards, including a plurality of coil boards 200 and a plurality of insert boards 250. Each insert board 250 is arranged between and adjacent to two coil boards 200. FIGS. 3A-3B illustrate the layers or boards of the wireless inductive charging apparatus 300 in an “exploded” or expanded view. FIG. 3C illustrates the layers or boards of the wireless inductive charging apparatus 300 placed adjacent to each other (e.g., pressed together) in a stacked formation.

The stacked formation of boards as shown in FIG. 3C illustrates an arrangement for use in an electric vehicle (such as the EV 110 in FIG. 1A). In embodiments, each of the coil boards 200 can be electrically coupled in parallel such that each of the inductive windings 210 on the coil boards 200 are thereby coupled in parallel. For example, if each coil board 200 has two inductive windings 210 (as described herein with reference to FIGS. 2A-2B), the two inductive windings 210 can be electrically coupled in parallel on each respective coil board 200, and then each coil board can be electrically coupled in parallel.

In embodiments, as shown in FIGS. 3A-3C, the coil boards 200 include positioning holes 230 (FIGS. 2A-2B, already discussed) and the insert boards 250 include positioning pins 270 (FIGS. 2C-2D, already discussed). When the coil boards 200 and insert boards 250 are placed adjacent to each other (e.g., pressed together) in a stacked formation, such as shown in FIG. 3C, the respective positioning pins 270 in the insert boards 250 line up with the and press into or engage respective positioning holes 230 in the coil boards 200 to place and maintain the coils boards 200 and the insert boards 250 in a vertical alignment. In particular, in such an arrangement (as shown in in FIG. 3C) the respective inductive windings 210 on the respective coil boards 200 are placed and maintained in vertical alignment. Maintaining the coil boards 200 in alignment provides advantages such as enabling stable transfer of power with reduced (e.g. lower) ripples or noise in the power, which improves quality of charging and helps prolong battery life.

When exposed to a changing magnetic field (such as, e.g., via a transmitter), the stacked formation of boards (including a plurality of coil boards 200 with respective inductive windings 210) transfers power from the changing magnetic field into electric power via inductive coupling. In this way, the wireless inductive charging apparatus 300 generates (e.g., provides) electric power when exposed to a changing magnetic field. The wireless charging apparatus can correspond to the receiver 130 (FIGS. 1A-1B, already discussed).

Thus, for example, the wireless inductive charging apparatus 300 includes a plurality of coil boards arranged in parallel, including a first coil board 200 and a second coil board 200, each coil board 200 comprising a substrate 220 and a first metallic trace forming a first inductive winding 210 disposed on a first surface of the substrate 220, and a first insert board 250 arranged between and adjacent to the first coil board 200 and the second coil board 200, the insert board 250 comprising an electrically-insulating and thermally-conductive material, the insert board 250 including a plurality of microchannels 260 to provide cooling to the first and second coil boards 200, where the first coil board 200, the insert board 250 and second coil board 200 are arranged in a stacked formation to generate (e.g., provide) electric power when exposed to a changing magnetic field.

In embodiments, each coil board 200 further comprises a second metallic trace forming a second inductive winding 210 disposed on a second surface of the substrate 220, wherein the second surface is on an opposite side of the substrate 220 relative to the first surface. In embodiments, for each coil board 200 the first and second inductive windings 210 are electrically coupled in parallel. In embodiments, each of the plurality of coil boards 200 is electrically coupled in parallel. In embodiments, the insert board 250 comprises a plurality of positioning pins 270 to assist alignment of the first and second coil boards. In embodiments, the insert board includes an opening to accommodate electrical connectors on each coil board coupled to the first and second inductive windings on each coil board respectively.

In some embodiments, the wireless inductive charging apparatus 300 further includes a shielding layer or board 310. The shielding board 310 can be constructed from a ferrite material or other material to provide electromagnetic shielding. The shielding board 310 can be placed on top of the stacked layers (coil boards 200 and insert board(s) 250). For example, when the wireless inductive charging apparatus 300 is placed (e.g., mounted) on the bottom of an electronic vehicle, the shielding board 310 acts to block (i.e., prevent, or reduce the amount of) the magnetic field from passing into the electric vehicle. In some embodiments, the shielding board 310 includes one more positioning pins located so as to line up with positioning hole(s) 230 on the coil board 200 (FIGS. 2A-2B, already discussed) to assist in alignment of the shielding board 310 and the top coil board 200.

In some embodiments, the wireless inductive charging apparatus 300 further includes a rectifier 320 placed on top of the wireless inductive charging apparatus 300. The rectifier 320 can include a rectifier circuit placed or disposed on a PCB. For example, if a shielding board 310 is present, the rectifier 320 can be placed on an opposite side of the shielding board 310 relative to the stacked layers. The rectifier 320 can correspond to the rectifier 140 (FIG. 1A) and/or the rectifier 180 (FIG. 1C).

Although the example charging apparatus 300 as illustrated in FIGS. 3A-3C shows five layers—comprising three coil boards 200, each separated by an insert board 250, it will be understood that or fewer or additional layers can be included in any particular embodiment of the charging apparatus 300. For example, the charging apparatus 300 can include three layers (two coil boards 200 separated by an insert board 250), seven layers (four coil boards 200, each separated by an insert board 250), nine layers (five coil boards 200, each separated by an insert board 250), etc. The number of layers can be selected based on the level of charging power to be provided by the charging apparatus 300. For example, in an embodiment the charging apparatus 300 can be selected with three layers (two coil boards 200, one insert board 250) to provide approximately 3 kW output power (such as, e.g., approximately 3.6 kW). As another example, in an embodiment the charging apparatus 300 can be selected with seven layers (four coil boards 200, three insert boards 250) to provide approximately 7 kW output power (such as, e.g., approximately 7.2 kW). As another example, in an embodiment the charging apparatus 300 can be selected with eleven layers (six coil boards 200, five insert boards 250) to provide approximately 11 kW output power. In some embodiments additional insulating or cooling layers can be included.

In embodiments, the insert board 250 is of a thickness of approximately the same as the thickness of the substrate 220 of the coil board 200; in such embodiments, when the coil board 200 has inductive windings on opposite surfaces, and a plurality of coil boards 200 are stacked with an insert board 250 between each two coil boards 200, the inductive windings 210 are spaced apart with the same spacing (e.g., equidistant spacing), or approximately the same spacing, throughout the apparatus 300. This enhances the modular design in that the same types of coil boards 200 and the same types of insert boards 250 can be used in the stacked arrangement.

FIG. 3D provides a diagram illustrating a wireless charging circuit 350 for use in an electric vehicle wireless inductive charging apparatus such as, e.g., the wireless inductive charging apparatus 300 according to one or more embodiments, with reference to components and features described herein including but not limited to the figures and associated description. The wireless charging circuit 350 includes a rectifier 320 and a series of coils (L), each coil (L) corresponding to one of the coil boards 200 in the stacked arrangement (when connected in parallel) for the wireless inductive charging apparatus 300. The coils (L) and the rectifier 320 of the wireless charging circuit 350 can correspond to the coil L₂ and the rectifier 180 in the wireless charging circuit 170 (FIG. 1C, already discussed), respectively. In embodiments the wireless charging circuit 350 can include additional components not shown in FIG. 3D.

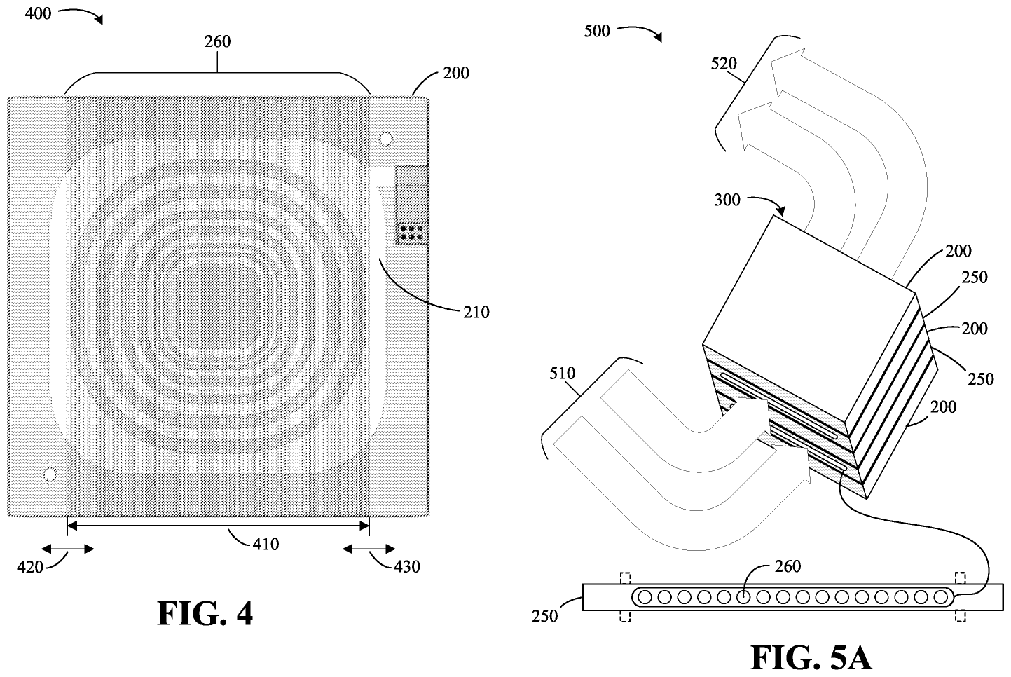

FIG. 4 is a diagram 400 illustrating aspects of an example of a wireless inductive charging apparatus such as, e.g., the wireless inductive charging apparatus 300 according to one or more embodiments, with reference to components and features described herein including but not limited to the figures and associated description. The diagram 400 illustrates an example of an overlay of a coil board 200 with a plurality of microchannels 260 in an insert board 250, to show an example of the positioning of the microchannels 260 relative to the coil board 200 when the insert board 250 is placed adjacent to the coil board 200.

In embodiments, the microchannels 260 extend a width 410 across the insert board so as to line up with at least a substantial portion of the inductive winding(s) 210 on the coil board 200. In various embodiments, the width 410 can be selected such that the microchannels 260 line up with at least a central portion of the inductive winding(s) 210 on the coil board 200, for example by moving the respective end locations 420, 430 of the microchannels 260 inward. In such embodiments, the microchannels 260 would “cover” the hottest portions of the inductive windings 210 during operation of the wireless inductive charging apparatus 300. In various embodiments, the width 410 can be selected such that the microchannels 260 line up with the entire width of the inductive winding(s) 210 on the coil board 200, for example by moving the respective end locations 420, 430 of the microchannels 260 outward. In various embodiments, the width 410 and the respective end locations 420, 430 of the microchannels 260 can be selected to provide cooling to various portions of the coil board 200, for example the innermost portion of the coil board 200 or increasing portions of the coil board 200 extending outward from the center.

It will be understood that, as illustrated in FIG. 4 and described herein with reference to FIGS. 2C-2D, the microchannels 260 extend through the length of the insert board 250 so as to permit a flow of coolant entering from one end of the insert board 250, flowing through the body of the insert board 250, and exiting from an opposite end of the insert board 250, thereby providing a cooling mechanism for the wireless inductive charging apparatus 300.

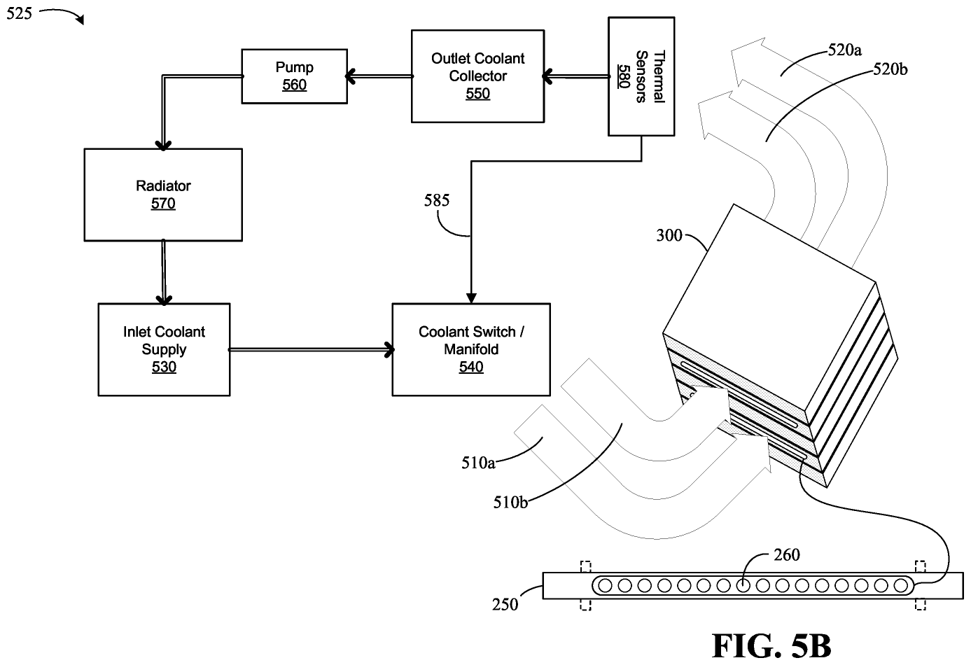

FIG. 5A provides a diagram 500 illustrating an example of a wireless inductive charging apparatus 300 with cooling according to one or more embodiments, with reference to components and features described herein including but not limited to the figures and associated description. The wireless inductive charging apparatus 300, as described herein with reference to FIGS. 3A-3C, has a plurality of stacked layers including coil boards 200 and insert boards 250 placed between the coil boards 200. As shown in the example of FIG. 5A, inlet cooling paths 510 provide flows of coolant to enter and pass through the microchannels 260 of the insert boards 250, and exit via outlet cooling paths 520. The inlet cooling paths 510 can connect to a coolant supply (e.g., a coolant reservoir, not shown in FIG. 5A), and outlet cooling paths 520 can connect to a coolant collector (not shown in FIG. 5A). The coolant can be an appropriate fluid to absorb and carry heat away from the apparatus, such as, e.g., water, ethylene glycol, other glycol-based fluid, etc.

The cooling paths 510 and 520 can include any appropriate mechanism for transporting coolant to each of the microchannels such as, e.g., via pipes, tubes, hoses, etc., and can be of a material to withstand the heat absorbed by the coolant such as fiberglass, rubber, etc. The cooling paths 510 and 520 can, in some embodiments, include a flexible material to permit bending or routing of the cooling paths 510 and 520. As an example, in some embodiments the inlet cooling paths 510 can include inlet fiberglass pipes, each inlet pipe connected at one end to the coolant supply and at the other end to a respective one of the microchannels 260. Similarly, in some embodiments the outlet cooling paths 520 can include outlet fiberglass pipes, each outlet pipe connected at one end to a respective one of the microchannels 260 (at the opposite end of the microchannel relative to the inlet pipe) and at the other end to the coolant collector. In some embodiments, a pump can cause the coolant collector to pass the outlet coolant though a radiator before recycling to the coolant supply. In some embodiments the inlet pipes and outlet pipes can be connected to the coolant supply via a fluid-connecting plug (e.g., quick-connect plug).

FIG. 5B provides a diagram illustrating an example of a wireless inductive charging apparatus 300 with a cooling system 525 according to one or more embodiments, with reference to components and features described herein including but not limited to the figures and associated description. Similar to FIG. 5A, the wireless inductive charging apparatus 300 in FIG. 5B has a plurality of stacked layers including coil boards 200 and insert boards 250 placed between the coil boards 200 (as described herein with reference to FIGS. 3A-3C). As shown in the example of FIG. 5B, inlet cooling paths 510 (labeled as 510a and 510b) provide flows of coolant to enter and pass through the microchannels 260 of the insert boards 250, and exit via outlet cooling paths 520 (labeled as 520a and 520b). For example, inlet cooling path 510a and outlet cooling path 520a connect to an inlet and outlet side of microchannels 260, respectively, for a first insert board 250 in the wireless inductive charging apparatus 300. Similarly, inlet cooling path 510b and outlet cooling path 520b connect to an inlet and outlet side of microchannels 260, respectively, for a second insert board 250 in the wireless inductive charging apparatus 300.

The cooling system 525 includes an inlet coolant supply 530, a coolant switch/manifold 540, an outlet coolant collector 550, thermal sensors 555, a pump 560, and a radiator 570. The inlet coolant supply 530 provides a supply of coolant. Under pressure produced by the pump 560, the coolant circulates from the inlet coolant supply 530 through the coolant switch/manifold 540, then through the inlet cooling paths 510a, 510b, through the wireless inductive charging apparatus 300 via microchannels 260, through the outlet cooling paths 520a, 520b to the outlet cooling collector 550, then through the radiator 570 and back to the inlet coolant supply 530. The pump 560 can be placed essentially anywhere in the coolant circulation path to provide the pressure to cause the fluid to circulate accordingly.

The coolant switch/manifold 540 provides switched or metered fluid connections from the inlet coolant supply 530 (e.g., via one or more manifolds) to inlet coolant paths 510a, 510b. The coolant switch/manifold can cause coolant flow through one or more paths to flow at the same or different rates varying from 0% (i.e., no flow) to 100% (i.e., full flow). One end of the coolant switch/manifold 540 is connected with the inlet coolant supply 530. In some embodiments, the coolant switch/manifold 540 includes a fluid manifold with separate coolant paths or channels.

In some embodiments, the coolant switch/manifold 540 includes a switch to switch fluid flow among the microchannels of an insert board, and/or among the inlet cooling paths 510a, 510b. In some embodiments, the coolant switch/manifold 540 includes a plug (e.g., a plastic plug with sealing for liquid leakage) with multiple channels for connecting to the insert board cooling microchannels. The plug can be a quick-connect plug. In embodiments the coolant switch/manifold 540 includes a second plug (e.g., quick-connect plug) with multiple channels such that a first plug is connected to an input side of the insert board cooling microchannels and a second plug is connected to an output side of the insert board cooling microchannels. The coolant switch/manifold 540 includes sealing capability and preferably is non-corrosive (or anti-corrosive). In embodiments the coolant switch/manifold 540 can be made of soft or flexible materials, such as rubber or plastic, to enhance flexibility in installation.

The thermal sensors 580 can measure or sense the temperature of the coolant flowing through each of the outlet cooling paths 520a, 520b. One or more signal or control lines 585 can provide control signals or commands to the coolant switch/manifold 540, causing the coolant switch/manifold to selectively modulate coolant flow to each of the inlet paths 510a and/or 510b. For example, if the temperature in outlet path 520a or 520b is below a threshold (e.g., a first threshold), such that less cooling is required, the respective thermal sensor can send a signal to the coolant switch/manifold 540 to reduce (or alternatively turn off) the coolant flow to the respective inlet coolant path 510a or 510b. As another example, if the temperature in outlet path 520a or 520b is above a threshold (e.g., a second threshold), such that more cooling is required, the respective thermal sensor can send a signal to the coolant switch/manifold 540 to increase (or alternatively turn on) the coolant flow to the respective inlet coolant path 510a or 510b. As another example, if the temperature in outlet path 520a or 520b is between a first threshold and a second threshold, such that the amount of cooling is sufficient, the respective thermal sensor can send no signal (or alternatively, send a maintain flow signal) to the coolant switch/manifold 540 to maintain the current coolant flow to the respective inlet coolant path 510a or 510b. In embodiments, the cooling system 525 can thereby adjust the amount of coolant flowing through each cooling layer (insert board 250 with microchannels 260) so as to maintain approximately even temperatures among the coil board layers.

While the cooling system 525 has been described with reference to an example of a wireless inductive charging apparatus 300 with three coil boards 200 and two insert boards 250 (with corresponding inlet cooling paths 510a, 510b and outlet cooling paths 520a, 520b), it will be understood that the cooling system 525 can accommodate other configurations of the wireless inductive charging apparatus 300 having additional numbers of coil boards 200 and insert boards 250, respectively. In embodiments, the temperatures are higher for the innermost layers and cooler for the outer layers of the wireless inductive charging apparatus 300. Accordingly, in some embodiments, the cooling system can be arranged to provide coolant only to a subset of boards on the within the inner layers of the wireless inductive charging apparatus 300, and not to the outermost boards.

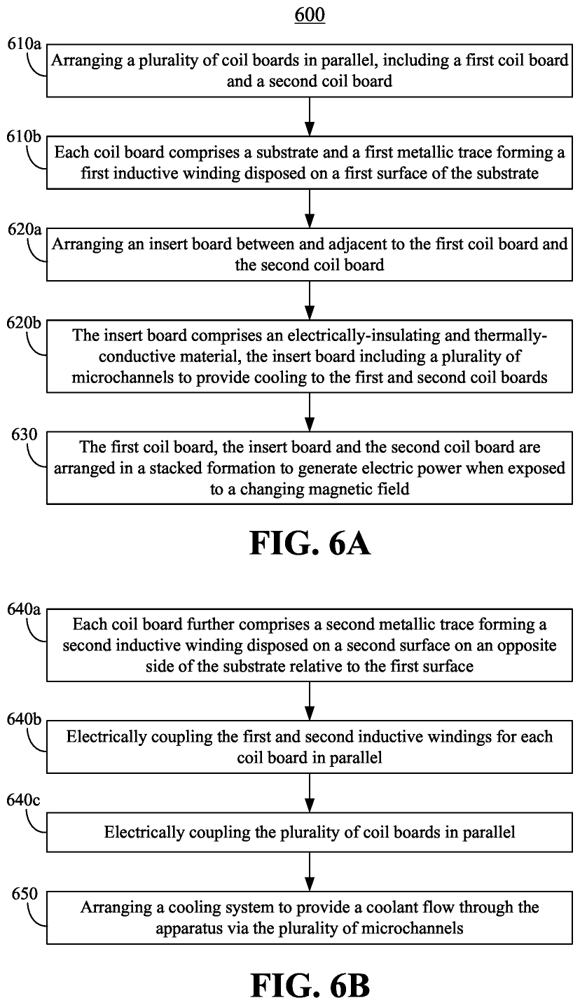

FIGS. 6A-6B provide flowcharts illustrating an example method 600 of constructing a wireless inductive charging apparatus according to one or more embodiments, with reference to components and features described herein including but not limited to the figures and associated description. The wireless inductive charging apparatus can include the wireless inductive charging apparatus 300, and components thereof, as described herein with reference to FIGS. 1A-1C, 2A-2D, 3A-3D, 4, and 5A-5B.

Turning to FIG. 6A, construction of a wireless inductive charging apparatus for use in an electric vehicle is described. Block 610a provides for arranging a plurality of coil boards in parallel, including a first coil board and a second coil board, where at block 610b each coil board comprises a substrate and a first metallic trace forming a first inductive winding disposed on a first surface of the substrate. Block 620a provides for arranging an insert board between and adjacent to the first coil board and the second coil board, where at block 620b the insert board comprises an electrically-insulating and thermally-conductive material, the insert board including a plurality of microchannels to provide cooling to the first and second coil boards. At block 630 the first coil board, the insert board and the second coil board are arranged in a stacked formation to generate (e.g., provide) electric power when exposed to a changing magnetic field.

Turning now to FIG. 6B, at block 640a, each coil board further comprises a second metallic trace forming a second inductive winding disposed on a second surface of the substrate, where the second surface is on an opposite side of the substrate relative to the first surface. Block 640b provides for electrically coupling the first and second inductive windings for each coil board in parallel. Block 640c provides for electrically coupling the plurality of coil boards in parallel. Block 650 provides for arranging a cooling system to provide a coolant flow through the apparatus via the plurality of microchannels.

The above described methods and systems may be readily combined together if desired. The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first,” “second,” etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. A wireless inductive charging apparatus comprising:
a plurality of coil boards arranged in parallel, including a first coil board and a second coil board, each coil board comprising:
a substrate; and
a first metallic trace forming a first inductive winding disposed on a first surface of the substrate; and
an insert board arranged between and adjacent to the first coil board and the second coil board, the insert board comprising an electrically-insulating and thermally-conductive material, the insert board including a plurality of microchannels to provide cooling to the first and second coil boards;
wherein the first coil board, the insert board and second coil board are arranged in a stacked formation to generate electric power when exposed to a changing magnetic field.

2. The apparatus of claim 1, wherein each coil board further comprises a second metallic trace forming a second inductive winding disposed on a second surface of the substrate, wherein the second surface is on an opposite side of the substrate relative to the first surface.

3. The apparatus of claim 2, wherein for each coil board the first and second inductive windings are electrically coupled in parallel.

4. The apparatus of claim 3, wherein each of the plurality of coil boards is electrically coupled in parallel.

5. The apparatus of claim 1, further comprising a cooling system arranged to provide a coolant flow through the apparatus via the plurality of microchannels.

6. The apparatus of claim 1, wherein the insert board comprises a plurality of positioning pins to assist alignment of the first and second coil boards.

7. The apparatus of claim 2, wherein the insert board includes an opening to accommodate electrical connectors on each coil board coupled to the first and second inductive windings on each coil board respectively.

8. The apparatus of claim 1, further comprising a shielding board arranged on an outward side of the apparatus to block passage of the changing magnetic field.

9. The apparatus of claim 8, further comprising a rectifier arranged on an opposite side of the shielding board relative to the plurality of coil boards, the rectifier electrically coupled to a power output of the plurality of coil boards.

10. A method of constructing an inductive charging apparatus comprising:
arranging a plurality of coil boards in parallel, including a first coil board and a second coil board, each coil board comprising:
a substrate; and
a first metallic trace forming a first inductive winding disposed on a first surface of the substrate; and
arranging an insert board between and adjacent to the first coil board and the second coil board, the insert board comprising an electrically-insulating and thermally-conductive material, the insert board including a plurality of microchannels to provide cooling to the first and second coil boards;
wherein the first coil board, the insert board and the second coil board are arranged in a stacked formation to generate electric power when exposed to a changing magnetic field.

11. The method of claim 10, wherein each coil board further comprises a second metallic trace forming a second inductive winding disposed on a second surface of the substrate, wherein the second surface is on an opposite side of the substrate relative to the first surface.

12. The method of claim 11, further comprising, for each coil board, electrically coupling the respective first and second inductive windings in parallel.

13. The method of claim 12, further comprising electrically coupling the plurality of coil boards in parallel.

14. The method of claim 10, further comprising arranging a cooling system to provide a coolant flow through the apparatus via the plurality of microchannels.

15. The method of claim 10, wherein the insert board comprises a plurality of positioning pins to assist alignment of the first and second coil boards.

16. The method of claim 11, wherein the insert board includes an opening to accommodate electrical connectors on each coil board coupled to the first and second inductive windings on each coil board respectively.

17. The method of claim 10, further comprising arranging a shielding board on an outward side of the apparatus to block passage of the changing magnetic field.

18. The method of claim 17, further comprising arranging a rectifier on an opposite side of the shielding board relative to the plurality of coil boards, the rectifier electrically coupled to a power output of the plurality of coil boards.

19. An electric vehicle inductive charging apparatus comprising:
a plurality of coil boards arranged in parallel, each coil board comprising:
a substrate; and
a first metallic trace forming a first inductive winding disposed on a first surface of the substrate;
a plurality of insert boards, each insert board arranged between and adjacent to a respective two of the plurality of coil boards, each insert board comprising an electrically-insulating material, each insert board including a plurality of microchannels to provide cooling to the respective adjacent coil boards; and
a cooling system to provide a coolant flow through the apparatus via the plurality of microchannels, the cooling system comprising a plurality of cooling paths and a manifold to modulate coolant flow among the respective insert boards;
wherein the plurality of coil boards and the plurality of insert boards are arranged in a stacked formation to generate electric power when exposed to a changing magnetic field.

20. The electric vehicle inductive charging apparatus of claim 19, wherein the plurality of coil boards includes a number of coil boards to provide a power level selected from power levels of approximately 3 kW, 7 kW or 11 kW.
